(19) United States
(12) Patent Application Publication
(10) Pub. No.: US 2018/0068760 A1
(43) Pub. Date: Mar. 8, 2018

(54) Compound Type Conductive Wire Structure

(71) Applicant: G.S. Electech Inc., Aichi (JP)

(72) Inventors: Shingo Okuda, Aichi (JP); Yoshihiro Sato, Aichi (JP); Takao Isogai, Aichi (JP)

(73) Assignee: G.S. Electech Inc., Aichi (JP)

(21) Appl. No.: 15/679,488

(22) Filed: Aug. 17, 2017

(30) Foreign Application Priority Data
Sep. 2, 2016 (JP) 2016-171825

(51) Int. Cl. H01B 7/04; H01B 9/00; H01B 7/00; C22C 9/02; H01B 3/30

(52) U.S. Cl. CPC H01B 7/04; H01B 9/006; H01B 3/302; C22C 9/02; H01B 7/0009

(57) ABSTRACT

In a compound type conductive wire structure 1, a plurality of wire-stranded portions 3 are provided to constitute main wire-twisted portions 5 embedded in an insulator matrix 2. Each of the wire-stranded portions 3 has a subsidiary wire-stranded portion 4 to serve as a diameter-reduced wire-twisted portion 8. Such is the structure that it enables to provide a flexibility, pliability and high strength with a diameter-increased wire-twisted portion 10, while securing a friction-resistant, vibration-resistant, impact-resistant and yet excellent bending capability. It is possible to prevent the main wire-twisted portions 5 from coming loose when removing a plastic layer coated over the main wire-twisted portion 5. The core wire 9 has a curved surface 9a which partly engages in surface-to-surface contact with the diameter-reduced wire-twisted portion 8. This makes it possible to evenly disperse stresses applied to the curved surface 9a of the core wire 9.

### BACKGROUND OF THE INVENTION

### Field of the Invention

The present invention relates to a compound type conductive wire structure which enables to secure an excellent bending and friction-resistant capabilities, and well-suited to a situation to which vibration and bending force are repeatedly applied.

### Description of Related Art

In the car-making industry, a wide variety of wire cables has been produced to various electric devices for the sake of the power-supply objective. These wire cables are used to connect various types of sensors to ABS (Anti-braking System), EPB (Electric Parking Brake), AVS (Adaptive Variable Suspension System), EMB (Electric Motor Brake) or WSS (Wheel Skid System). Among those devices, EMB will be used in the not too distant future.

In general, the mild copper has been used as the material of an electric wire, and thirty-seven wire elements (e.g., 0.26 mm in diameter) are stranded to secure a predetermined level of electric capacity.

Upon routing the wires at a place to which vibration and bending force are repeatedly applied, it is necessary to arrange the SN-curve so as not to invite the disconnection (rupture) before the repetitive bending actions reach one million times.

By way of illustration, thirty-seven wire elements (e.g., 0.26 mm in diameter) are stranded to form an electric conductor with its cross sectional area determined as 2.0 square millimeter. Four electric conductors of this type have been used to implement the repetitive bending experimentation as disclosed by Japanese laid-open patent application No. 2005-197135 (referred hereinafter as a first prior art), however, it is by no means possible to accomplish the bending capability up to a required level.

Japanese laid-open patent application No. 06-251633 (referred hereinafter as a second prior art) discloses a multi-layered cable structure in which a plurality of wire elements are concentrically stranded, so that the stranded wires are circularly rolled and compacted to occupy their cross sectional area by more than 99%. The stranded wires thus compacted achieves a high flexibility to provide a press-fit type terminal wire with a high reliability.

Japanese laid-open patent application No. 2012-146431 (referred hereinafter as a third prior art) discloses an electric conductor in which three metallic wires are stranded and bonded by a ultrasonic welding machine so as to ameliorate the welding strength.

In the third prior art, Cu—Sn based alloy, Cu—Mg based alloy, Cu—Ag based alloy or Cu—Ni—Si based alloy has been used to determine their tensile strength within 400-1300 MPa.

Japanese laid-open patent application No. 2015-86452 (referred hereinafter as a fourth prior art) discloses stranded wires, insulated wire and wire harness which have been used as automobile conductors. These automobile conductors exhibit a good ductile property and higher strength with a less amount of cross sectional area so as to enhance a pealing resistance with an excellent impact-durability.

Specifically, the metallic wire elements are determined to lengthen more than 5% with an oxygen content not more than 20 ppm, while rendering an electric conductivity more than 62% IACS (International Annealed Copper Standard) with a tensile strength as more than 450 MPa.

Japanese laid-open patent application No. 2011-192533 (referred hereinafter as a fifth prior art) discloses an excellent bending resistant cable which enables to attain a sufficient bending resistance and tensile strength while minimizing the friction among the wire elements to the lower limit.

In the fifth prior art, a plurality of thin wires are stranded to form a minor wire-stranded body. A plurality of the minor wire-stranded bodies are stranded in a manner to be placed in a circumferential direction. In this instance, one minor wire-stranded body is turned opposite to the neighboring minor wire-stranded body.

Among the conductor cables, an electric cable used to routing the wire around the ABS (Anti-braking System) has been known as an ABS sensing cable (S) as observed in FIG. 21.

In the ABS sensing cable (S), two insulator cables 50, 51 are covered by a polyurethane elastomer sheath 52. The polyurethane elastomer sheath 52 is formed due to chemical cross-linkage by electronic beam radiation to provide a thermoplastic synthetic resin. The ABS sensing cable (S) serves as a signal carrier connected between an electronic control unit (ECU) and a wheel sensor to detect a revolution from the vehicular wheel. The ABS sensing cable (S) is routed so that the ABS sensing cable (S) exposes its middle portion from the electronic control unit (ECU) to a reverse side of the vehicular body. The ABS sensing cable (S) introduces its other end portion to a shock-absorber of the wheel suspension to be resultantly exposed to a severe environment.

For this reason, it is necessary for the ABS sensing cable (S) to have an impact-resistant property enough to remain intact when the ABS sensing cable (S) is subjected to stone strikes jumped from the road at the time of running the vehicle on the road.

As an example of the impact-resistant ABS sensing cable, as shown in FIGS. 22 and 23, each of the insulated cables 50, 51 composes a major wire-stranded conductor 54 which has three minor wire-stranded conductors 53. Each of the minor wire-stranded conductors 53 has a central copper-alloyed wire 53a. Around the central copper-alloyed wire 53a, six copper-alloyed wire 53b and nine middle copper-alloyed wire 53c are tightly placed in turn and embedded in a plastic insulator 55 (e.g., polyethylene).

From the reason that the number of the minor wire-stranded conductors 53 is three, and the numbers of the copper-alloyed wires 53a, 53b and 53c are 1, 6 and 9 in turn with the diametric dimension determined as 0.08 mm, the minor wire-stranded conductors 53 are generally formulated as (3/16/φ0.08) in practice.

The copper-alloyed wires 53a, 53b, 53c formulated as (3/16/φ0.08), however, displaces the copper-alloyed wire 53c from the center of the wires 53a, 53b, thereby making it difficult to concentrically stack copper-alloyed wires 53a, 53b, 53c. This makes it by no means easy to force the minor wire-stranded conductor 53 through a metallic mold dice (E) as shown in FIG. 24.

This makes it difficult to tightly roll or bundle the copper-alloyed wires 53a, 53b and 53c concentrically by means of the metallic mold dice (E).

Such is the structure that the copper-alloyed wires 53a, 53b, 53c loose inconveniently come loose due to their spring-back phenomenon when removing the plastic insulator 55 from the ABS sensing cable (S) to caulk the ABS sensing cable (S) to a barrel body 56a of the connector terminal 56 as shown in FIG. 25.

In the first prior art, in order to achieve a higher bending capability for the electric conductor, the electric conductor is formed by twisting a plurality of thin wires to provide a bundle of the thin wires which are made of Cu—Sn alloy (Sn: 0.2-0.3%, Cu: rest of the alloy).

Several bundles of the thin wires are stranded to form a diameter-increased strand. A plurality of the diameter-increased strands are twisted to form a double-stranded conductive wire structure.

In the recent car-making industries, however, an emphasis is put on making the vehicular body light-weight. From this point of view, the same is directed to the wire harness apparatuses. Although the first prior art aims to achieve the high bending capability, it is not sufficient from the viewpoint of securing the light-weight wire harness apparatuses.

Further, since the wire harness has a tendency to be exposed outside the vehicular floor during the wire-routing operation, it is required that the wire harness should have a high strength and should be impact-resistant enough to withstand the stone strikes jumping from the road at the time of running the vehicle on the road.

In the second through five prior arts, these prior arts achieve their own purposes and have structures characteristics of the corresponding prior arts. These prior arts however, have rooms for improvements from the viewpoint of securing the light-weight wire harness apparatuses.

In the ABS sensing cable (S), the minor wire-stranded conductor 53 is not capable enough to tightly bundle the wires 53a, 53b and 53c by means of compaction.

This results the wires 53a, 53b, 53c inconveniently in coming loose when removing the plastic insulator 55 coated over the minor wire-stranded conductor 53 at the time of connecting the terminal.

Therefore, the present invention has been made with the above drawbacks in mind, it is a main object of the invention to provide a compound type conductive wire structure which is capable to provide a flexibility, pliability and high strength with a diameter-increased wire-twisted portion, while securing a friction-resistant, vibration-resistant, impact-resistant and yet excellent bending property, thus preventing main wire-twisted portions from coming loose when removing a plastic layer coated over a main wire-twisted portion.

### SUMMARY OF THE INVENTION

According to the present invention, there is provided a compound type conductive wire structure, a single wire-stranded portion or a plurality of wire-stranded portions are provided to constitute a main wire-twisted portion or main wire-twisted portions embedded in an insulator matrix. Each of the wire-stranded portions has a subsidiary wire-stranded portion to serve as a diameter-reduced wire-twisted portion. The subsidiary wire-stranded portion has the central wire and a plurality of wire-stranded layers, each layer of which forms a plurality of thin wires surrounding the central wire to serve as the diameter-reduced wire-twisted portion.

Number of the thin wires residing at each of the wire-stranded layers are determined respectively so as to place the central wire in concentric relationship with each of the wire-stranded layers. A plurality of the diameter-reduced wire-twisted portions are bundled and stranded around a core wire to constitute the main wire-twisted portions as a diameter-increased wire-twisted portion. An outer surface of the core wire forms a curved surface which engages in surface-to-surface contact with a part of the diameter-reduced wire-twisted portion.

With a plurality of the wire-stranded portions provided to constitute the main wire-twisted portions embedded in an insulator matrix. Each of the wire-stranded portions has the subsidiary wire-stranded portion to serve as the diameter-reduced wire-twisted portion.

Such is the structure that it enables to provide a flexibility, pliability and high strength with the diameter-increased wire-twisted portion, while securing the friction-resistant, vibration-resistant, impact-resistant and yet excellent bending properties.

Since the number of the thin wires residing at each of the wire-stranded layers are determined respectively so as to place the central wire in concentric relationship with each of the wire-stranded layers, it is possible to prevent the main wire-twisted portions from coming loose when removing a plastic layer coated over the main wire-twisted portion at the time of connecting the terminal.

From the reason that the core wire has the curved surface which partly engages in surface-to-surface contact with the diameter-reduced wire-twisted portion, it is possible to evenly disperse stresses applied to the curved surface of the core wire so as to avoid the disconnection.

According to other aspect of the present invention, the wire-stranded layer structure forms two layers constituting a first and second layer. The first layer surrounding the central wire has six of the thin wires, and the second layers which surrounds the first layer has twelve of the thin wires.

This makes it possible to concentrically place the central wire with the wire-stranded layers (thin wires), and enables to tightly contract the thin wires by means of compaction, thereby achieving the light-weight wire harness structure of high strength with the excellent bending performance and vibration-resistant property.

According to other aspect of the present invention, the outer surface of the core wire forms a spiral groove around an axial direction of the core wire. The diameter-reduced wire-twisted portion is placed along the spiral groove. This makes it possible to stabilize the diameter-reduced wire-twisted portion on the core wire.

According to other aspect of the present invention, the core wire forms a hollow tube provided to communicate the core wire with connectors when the connectors are each connected to corresponding end of the diameter-increased wire-twisted portion.

With the core wire formed as the hollow tube, it is possible to communicate an inner space of the core wire with the connectors, thus avoiding the inner space from remaining vacuum. This makes it possible to prevent the humidified air from invading the inner space of the core wire, whereby avoiding electronic elements from being wet.

According to other aspect of the present invention, the core wire is made from polyurethane. This makes it possible to render the core wire to be more flexible and pliable so as to obtain an excellent bending property.

According to other aspect of the present invention, the core wire is made from a shape-memory polymer, so that the core wire deforms around an axial direction of the core wire in accompany with the ambient temperature rise.

This makes it possible to tightly wind the diameter-reduced wire-twisted portion relatively around the core wire in a wire-stranding direction of the diameter-reduced wire-twisted portion, so as to avoid the diameter-increased wire-twisted portion from coming loose.

### BRIEF DESCRIPTION OF THE DRAWINGS

A preferred form of the present invention is illustrated in the accompanying drawings in which:

FIG. 1 is an enlarged cross sectional view of a compound type conductive wire structure according to a first embodiment of the invention;

FIG. 2 is an exploded view of a core wire and subsidiary wire-stranded portions;

FIG. 3 is an assembly view in which the subsidiary wire-stranded portions are attached to the core wire to form a main wire-twisted portion;

FIG. 4 is a perspective view of the core wire;

FIG. 5 is a perspective view of the core wire spirally twisted around an axial direction to form a spiral groove;

FIGS. 6 and 7 are perspective views of the main wire-twisted portion:

FIG. 8 is a perspective view of the core wire which serves as a hollow tube according to a second embodiment of the invention;

FIG. 9 is a perspective view of the core wire spirally twisted around an axial direction to form the spiral groove;

FIG. 10 is a plan view of a compound type conductive wire structure, each end of which is connected to the corresponding connector;

FIGS. 11 through 13 are latitudinal cross sectional views of the main wire-twisted portion in which the core wires have different shapes each other according to a third embodiment of the invention;

FIGS. 14 through 16 are latitudinal cross sectional views of the main wire-twisted portion in which the core wire serves as the hollow tube and having different shapes each other according to a fourth embodiment of the invention;

FIGS. 17 through 20 are latitudinal cross sectional views of the main wire-twisted portion in which cross sections of inner spaces of the core wire has a different shape each other according to a fifth embodiment of the invention;

FIG. 21 is a perspective view of an ABS sensing cable (prior art);

FIG. 22 is a latitudinal cross sectional view of the ABS sensing cable (prior art);

FIG. 23 is a latitudinal cross sectional view of an insulated cable composing a major wire-stranded conductor which has three minor wire-stranded conductors (prior art);

FIG. 24 is a plan view of a metallic mold die and a minor wire-stranded conductor (prior art); and

FIG. 25 is a perspective view of the ABS sensing cable which is to be connected to a terminal (prior art).

### DETAILED DESCRIPTION OF PREFERRED EMBODIMENTS

In the following description of the depicted embodiments, the same reference numerals are used for features of the same type.

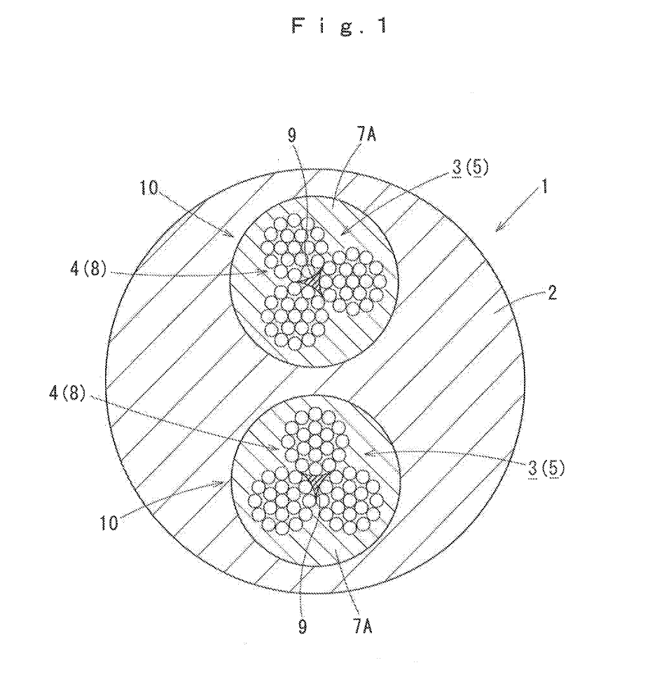

Referring to FIGS. 1 through 7, depicted is a compound type conductive wire structure 1 according to a first embodiment of the invention. The compound type conductive wire structure 1 is applied to electronic devices such as, for example, ABS (Anti-braking System) or EPB (Electric Parking Brake) mounted on a vehicular body. The compound type conductive wire structure 1 is used as a signal transmission to connect the electronic devices (not shown) to the electronic control unit (ECU). Power supply (not shown) is a battery pack in which thickness-reduced rectangular battery cells are stacked in the right-and-left direction in a low to form a cellular laminate so as to use as a secondary battery cell.

By way of illustration, the compound type conductive wire structure 1 measures 0.40 mm in diameter (generally represented by φ0.40) and having two wire-stranded portions 3 embedded in an insulator matrix 2 as shown in FIG. 1.

It is to be noted that instead of the two wire-stranded portions 3, a single wire-stranded portion 3 may be provided.

One of the wire-stranded portions 3 is connected to a positive terminal of the battery pack, and the other of the wire-stranded portions 3 is connected to a negative terminal of the battery pack. Each of the wire-stranded portions 3 is formed by twisting the subsidiary wire-stranded portion 4 around the core wire 9 to provide a counterpart of main wire-twisted portions 5. Each of the wire-stranded portions 3 has a subsidiary wire-stranded portion 4 which serves as a diameter-reduced wire-twisted portion 8. In accompany with a single wire-stranded portion 3, a single main wire-twisted portion 5 may be provided.

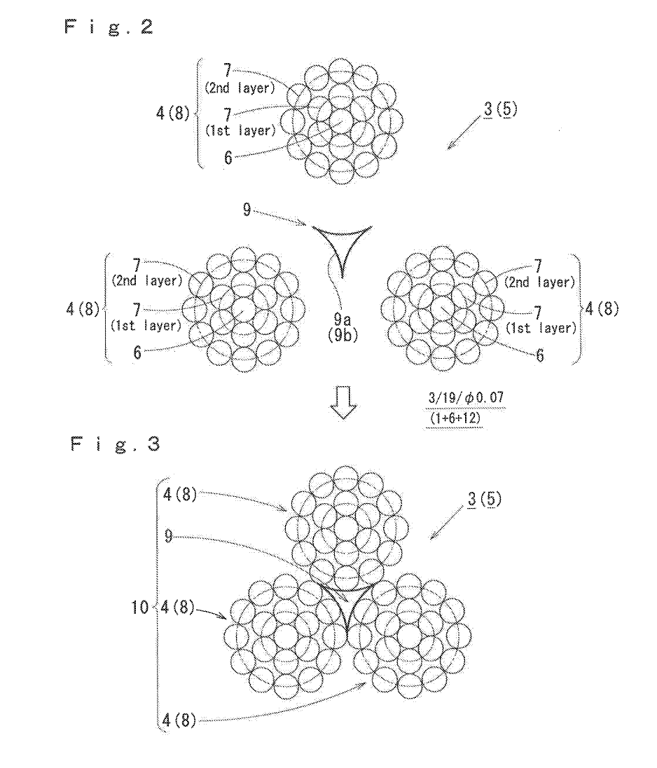

As shown in FIG. 2, the subsidiary wire-stranded portion 4 has a central wire 6 (e.g., 0.07 mm in diameter) and a plurality of wire-stranded layers. Each of the layers forms a plurality of thin wires 7 (a group of thin wires 7) to tightly surround the central wire 6 so that the subsidiary wire-stranded portion 4 serves as the diameter-reduced wire-twisted portion 8. The diameter-reduced wire-twisted portion 8 is embedded integrally in an insulator sheath 7A (e.g., polyethylene).

In this instance, around the single central wire 6, the subsidiary wire-stranded portion 4 has six thin wires 7 as a first layer and having twelve thin wires as a second layer around the first layer. The number of the thin wires 7 are such that the first layer (first group of thin wires 7) and second layer (second group of thin wires 7) can be arranged to be concentrically placed around central wire 6.

This makes it possible to prevent the outermost layer (second group of thin wires 7) to displace out of both the central wire 6 and the other layer (first group of thin wires 7). This enables the subsidiary wire-stranded portion 4 to forcibly pass through a metallic mold die (not shown) to roll and compact the subsidiary wire-stranded portion 4 to obtain a predetermined compaction rate (e.g., 1.0%-20%).

Since the first layer forms the six thin wires 7 and the second layer forms the twelve thin wires 7, and the central wire 7 and each of the thin wires 7 have the same diameter (0.07 mm), the subsidiary wire-stranded portion 4 is practically formulated as (3/19/φ0.07).

Upon making the main wire-twisted portions 5 as shown in FIG. 3, a plurality of the diameter-reduced wire-twisted portions 8 are bundled, rolled and stranded around a core wire 9 to constitute a diameter-increased wire-twisted portion 10 (e.g., 0.35 mm in diameter) in the main wire-twisted portions 5.

In this instance, an outer surface of the core wire 9 forms a curved surface 9a which engages in surface-to-surface contact with a part of the diameter-reduced wire-twisted portion 8.

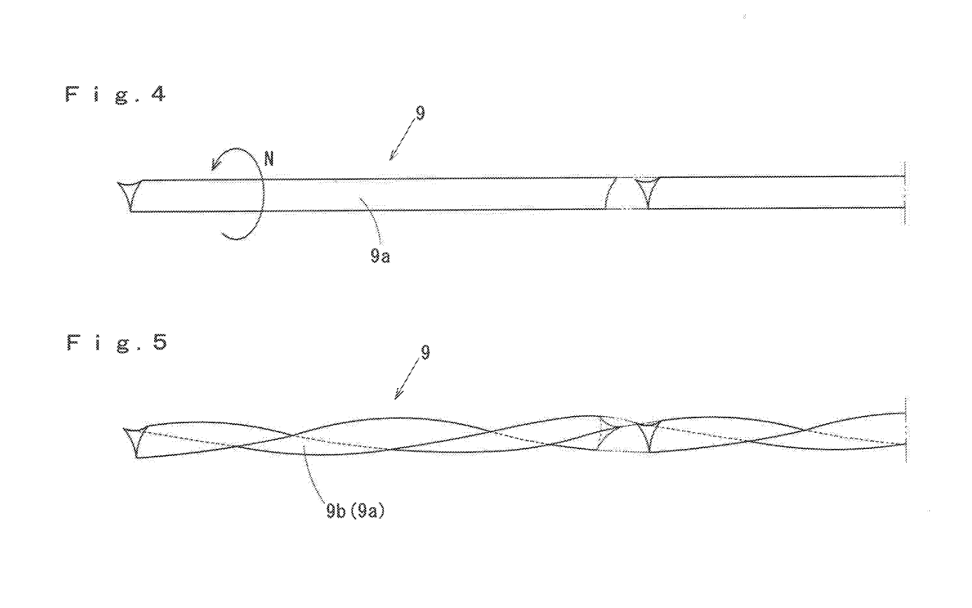

The core wire 9 is made of a synthetic resin (e.g., polyethylene) superior in flexibility and pliability, and has a cross section somewhat concaved inward to form a curved triangular configuration as shown in FIG. 4.

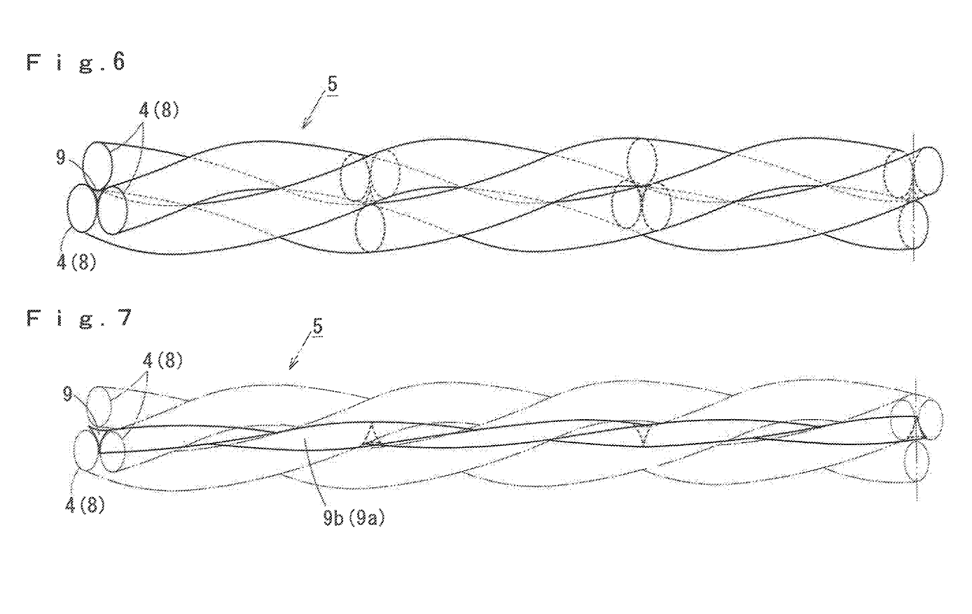

Around an axial direction (N) of the core wire 9, the core wire 9 is twisted at a predetermined pitch to form a spiral groove 9b. Along the spiral groove 9b, the diameter-reduced wire-twisted portion 8 is placed in position as shown in FIG. 5. This makes it possible to engage a part of the diameter-reduced wire-twisted portion 8 with an inner surface 9a of the spiral groove 9b, so as to stabilize the diameter-reduced wire-twisted portion 8 against the spiral groove 9b as shown in FIGS. 6 and 7.

It is to be noted that the single central wire 6, the bundle of the thin wires 7, the diameter-reduced wire-twisted portion 8 and the diameter-increased wire-twisted portion 10 are substantially circular in cross section.

As regard these wires 6, 7 and 10, one or more metallic components (Sn, Ni, In, Zn, Cr, Al, and P) should be added selectively to the copper-based alloy within the range of 0.01-0.30 wt % against the copper-based alloy. Upon forming the core wire 9, a rubber-like material such as, for example, EPDM (ethylene-propylene methylene diene linkage) may be used instead of polyethylene.

With the structure thus far described, a plurality of the wire-stranded portions 3 are provided to constitute the main wire-twisted portions 5 embedded in the insulator matrix 2. Each of the wire-stranded portions 3 has the subsidiary wire-stranded portion 4 which serves as the diameter-reduced wire-twisted portion 8.

Such is the structure that it enables to provide a flexibility, pliability and high strength with the diameter-increased wire-twisted portion 10, while securing the friction-resistant, vibration-resistant, impact-resistant and yet excellent bending capability.

Since the number of the thin wires 7 residing at each of the wire-stranded layer structures are determined respectively so as to place the central wire 6 in concentric relationship with each of the wire-stranded layers, it is possible to prevent the main wire-twisted portions 5 from coming loose when removing the insulator sheath 7A coated over the main wire-twisted portion 5 at the time of connecting the terminal (not shown).

From the reason that the core wire 9 has the curved surface 9a which partly engages in surface-to-surface contact with the diameter-reduced wire-twisted portion 8, it is possible to evenly disperse stresses applied to the curved surface of the core wire 9 so as to avoid the disconnection.

Since each of the wire-stranded layer structures forms two layers constituting a first and second layer. The first layer surrounding the central wire 6 has six of the thin wires 7, and the second layer surrounding the first layer has twelve of the thin wires 7.

This makes it possible to concentrically place the central wire 6 with the wire-stranded layers (group of the thin wires 7), and enables to tightly contract the thin wires 7 by means of compaction, thereby achieving the light-weight wire harness structure of high strength with the excellent bending performance and vibration-resistant capability.

It is to be noted that instead of the two wire-stranded portions 3, only one wire-stranded portion may be employed.

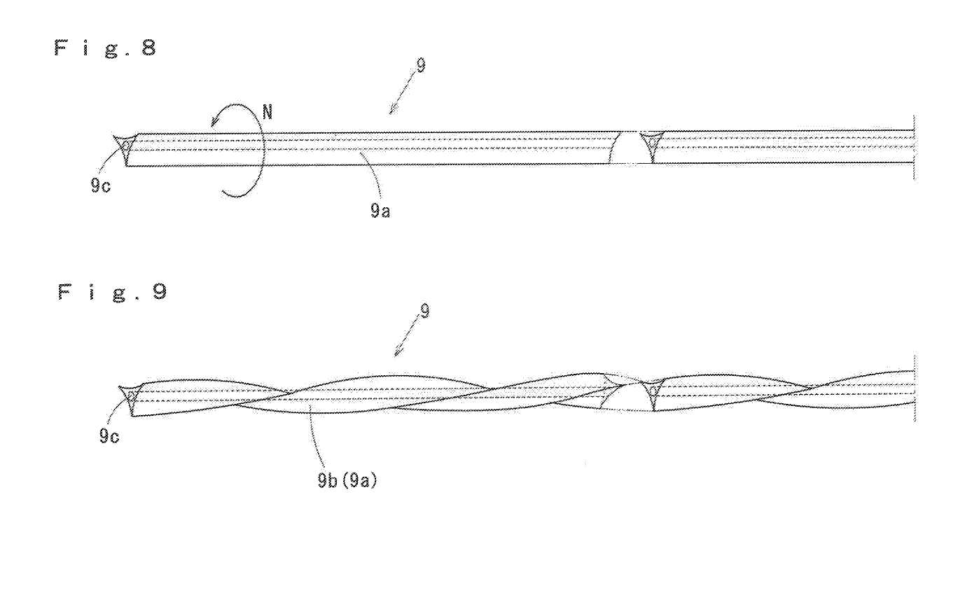

FIGS. 8 through 10 show a second embodiment of the invention in which the core wire 9 is formed in the shape of a hollow tube as shown in FIG. 8. Along the core wire 9, the core wire 9 has an inner space 9c and twisted around the axial direction (N) to shape a spiral tube structure as shown in FIG. 9.

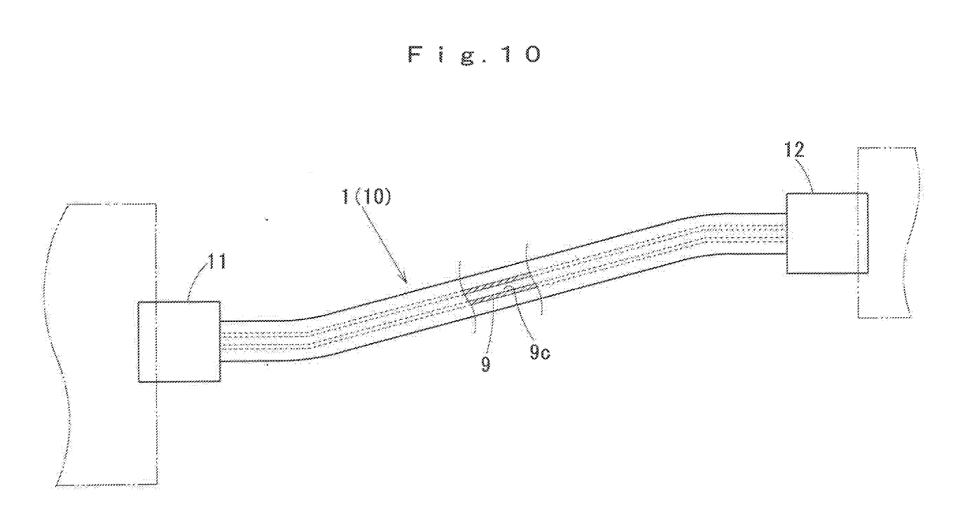

In this instance, the diameter-increased wire-twisted portion 10 (compound type conductive wire structure 1) connects one end to a first connector 11 and the other end to a second connector 12 as shown in FIG. 10.

In this situation, an ABS sensing cable (not shown) is provided as one example to act as a signal carrier through the connectors 11, 12 between an electronic control unit (ECU) and a wheel sensor (not shown) to detect a revolution (rpm) from a vehicular wheel.

Since the core wire 9 is formed as the hollow tube, it is possible to communicate the inner space 9c of the core wire 9 with the connectors 11, 12, thus substantially avoiding the inner space 9 from remaining vacuum. This makes it possible to prevent the humidified air from invading the inner space 9c of the core wire 9, whereby avoiding electronic elements (not shown) from being wet.

FIGS. 11 through 13 show a third embodiment of the invention in which the core wires 9 have different shapes each other in the main wire-twisted portion 5.

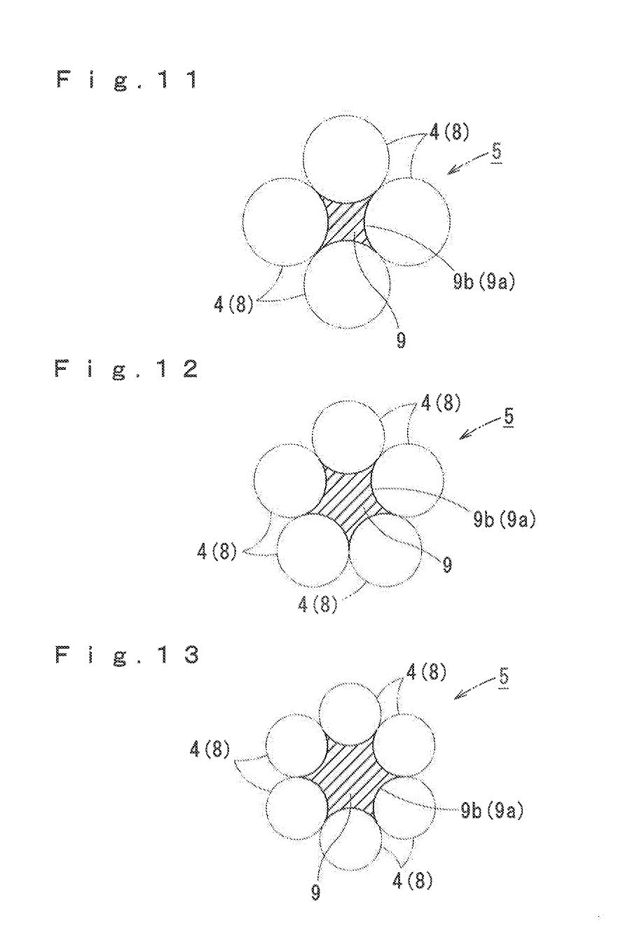

In FIG. 11, the core wire 9 has a cross section, each side of which is somewhat concaved inward to form a curved rectangular surface. In FIG. 12, the core wire 9 has a cross section, each side of which is somewhat concaved inward to form a curved pentagonal surface. In FIG. 13, the core wire 9 has a cross section, each side of which is somewhat concaved inward to form a curved pentagonal surface.

In this situation, a part of the subsidiary wire-stranded portion 4 engages with the curved surface 9a through the surface-to-surface contact.

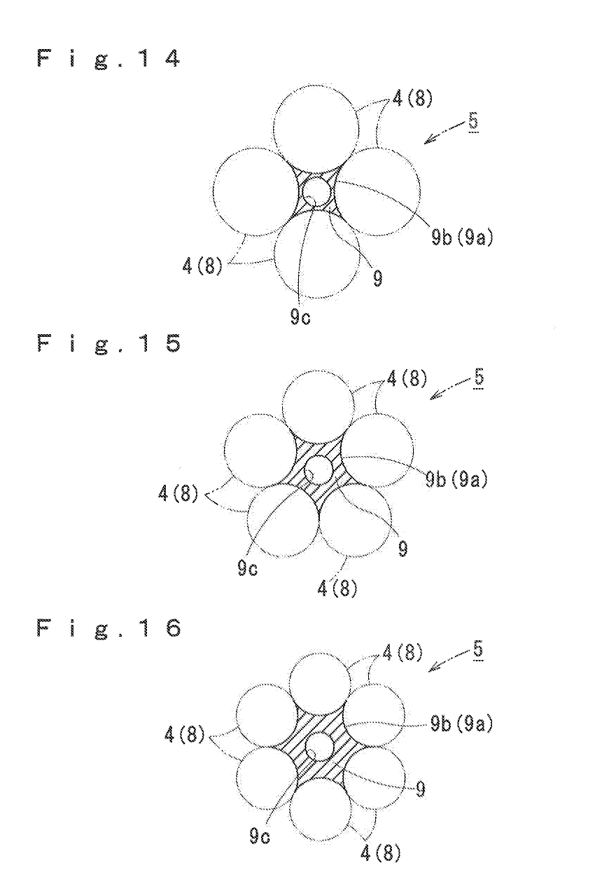

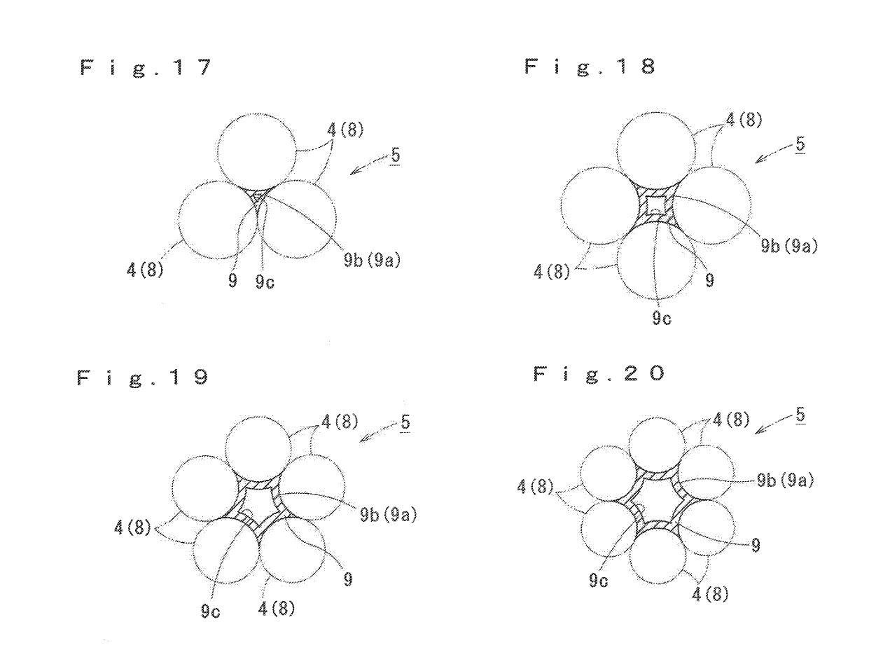

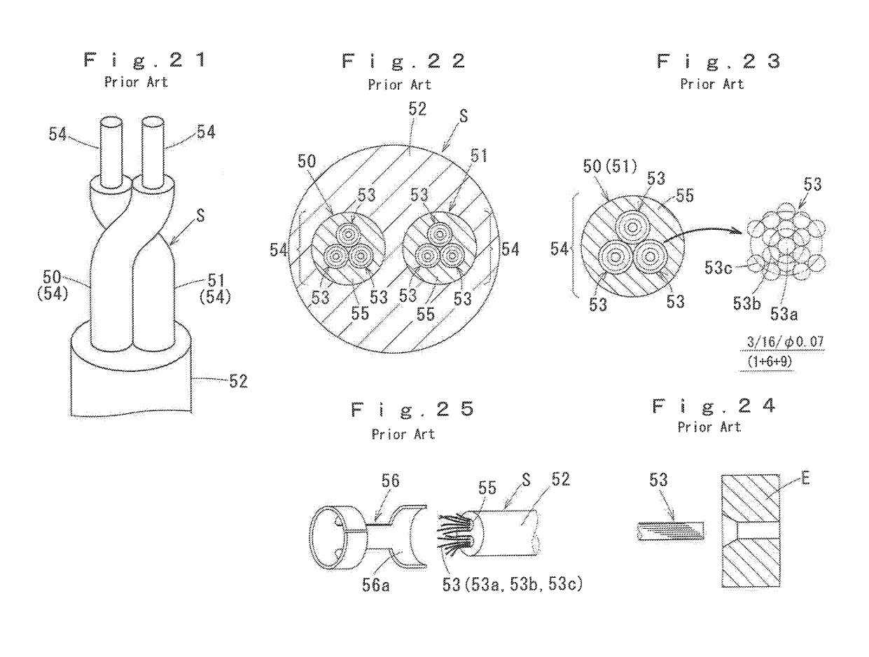

FIGS. 14 through 16 show a fourth embodiment of the invention in which the core wire 9 has the inner space 9c extended along the lengthwise direction of the core wire 9 in the third embodiment of the invention. When the diameter-increased wire-twisted portion 10 (compound type conductive wire structure 1) connects one end to a first connector 11 and the other end to a second connector 12, it is possible to obtain the same advantages as attained in the second embodiment of the invention.

As a modification form of the present invention, the core wire 9 may be made from a shape-memory polymer, so that the core wire 9 deforms around the axial direction (N) in accompany with an ambient temperature rise.

This makes it possible to tightly wind the diameter-reduced wire-twisted portion 8 relatively around the core wire 9 in a wire-stranding direction of the diameter-reduced wire-twisted portion 8.

Instead of polyurethane, the wire core 9 may be formed by the synthetic resin selectively adopted from the engineering plastics including polyimide (PA), polyester, polyimide, polyimide-imide, polyacetal (polyoxymethylene (PO M)), polycarbonate (PC), polyphenyleneether (PPE), polybutylenetelephthalate (PBT), polyethylenetelephthalate (PET), polyethylene (PE), polytetrafluoroethylene (PTFE) and syndiotacticpolystyrene (SPS).

It is to be noted that the numerical relationship between the number of the thin wires 7 in the first layer and the number of the thin wires 7 in the second layer, may be appropriately altered so much as the first layer and the second layer can be concentrically placed.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

What is claimed is:

1. A compound type conductive wire structure in which a single wire-stranded portion or a plurality of wire-stranded portions are provided to constitute a main wire-twisted portion or main wire-twisted portions embedded in an insulator matrix, each of said wire-stranded portions having a subsidiary wire-stranded portion which serves as a diameter-reduced wire-twisted portion;
said subsidiary wire-stranded portion having a central wire and a plurality of wire-stranded layers, each layer of which forms a plurality of thin wires to tightly surround said central wire as said diameter-reduced wire-twisted portion;
number of said thin wires residing at each of said wire-stranded layers being determined respectively so as to place said central wire in concentric relationship with each of said wire-stranded layers;
a plurality of said diameter-reduced wire-twisted portions being bundled and stranded around a core wire to constitute a diameter-increased wire-twisted portion in said main wire-twisted portions; and
an outer surface of said core wire forming a curved surface which engages in surface-to-surface contact with a part of said diameter-reduced wire-twisted portion.

2. A compound conductive wire structure according to claim 1, wherein each of said wire-stranded layers forms two layers constituting a first layer and a second layer, said first layer surrounding said central wire has six of said thin wires and said second layer surrounding said first layer has twelve of said thin wires.

3. A compound type conductive wire structure according to claim 1, wherein said outer surface of said core wire forms a spiral groove around an axial direction of said core wire, and said diameter-reduced wire-twisted portion is placed along said spiral groove.

4. A compound type conductive wire structure according to claim 1, wherein said core wire forms a hollow tube provided to communicate said core wire with connectors when said connectors are each connected to corresponding end of said diameter-increased wire-twisted portion.

5. A compound type conductive wire structure according to claim 1, wherein said core wire is made from polyurethane.

6. A compound type conductive wire structure according to claim 1, wherein said core wire is made from a shape-memory polymer, so that said core wire deforms around an axial direction of said core wire in accompany with an ambient temperature rise so as to tightly wind said diameter-reduced wire-twisted portion relatively around said core wire in a wire-stranding direction of said diameter-reduced wire-twisted portion.
